(19) United States
(12) Patent Application Publication
(10) Pub. No.: US 2022/0220380 A1
(43) Pub. Date: Jul. 14, 2022

(54) Corrosion Inhibiting Product for Closed Loop Water Systems

(71) Applicant: Ecolab USA Inc., St. Paul, MN (US)

(72) Inventors: Zhangzhang Yin, Aurora, IL (US); Bingzhi Chen, Naperville, IL (US); Xuejun Wang, Naperville, IL (US)

(73) Assignee: Ecolab USA Inc., St. Paul, MN (US)

(21) Appl. No.: 17/570,715

(22) Filed: Jan. 7, 2022

Related U.S. Application Data
(60) Provisional application No. 63/135,093, filed on Jan. 8, 2021.

(51) Int. Cl. C09K 15/30; C09K 15/06; C09K 15/02; C09K 15/22; C02F 5/08; C23F 11/12; C23F 11/18; C23F 11/14

(52) U.S. Cl. CPC C09K 15/30; C09K 15/06; C09K 15/02; C09K 15/22; C02F 2303/08; C23F 11/124; C23F 11/181; C23F 11/149; C02F 5/08

(57) ABSTRACT

The invention provides a product for inhibiting corrosion in a closed loop industrial water system containing a corrosion sensitive metal, the product comprising: a carboxylic acid-based corrosion inhibitor, an azole-based corrosion inhibitor, a nitrate-based corrosion inhibitor, and water. The invention also provides a method of inhibiting corrosion of a corrosion sensitive metal in a closed loop industrial water system, the method comprising treating water in the system with product of the invention, to provide treated water.

### CROSS-REFERENCE TO RELATED APPLICATIONS

This patent application claims the benefit of U.S. Provisional Patent Application No. 63/135,093, filed Jan. 8, 2021, the disclosure of which is incorporated herein by reference for all purposes.

### BACKGROUND OF THE INVENTION

High strength aluminum alloys (e.g., Al 2000 series and Al 7000 series) are being increasingly utilized in industrial water systems, particularly closed loop water systems, such as, e.g., injection molds and semiconductor tools. High strength aluminum alloys are being increasingly used for such applications, in part, because high strength aluminum offers many advantages over steel in such applications. For example, fabrication of molds and tools using high strength aluminum alloys can be easier due to better machinability and ease of polishing. In addition, aluminum dissipates heat up to seven times faster than steel, thereby reducing molding cycles by 20 to 50 percent. The exposure of aluminum parts in industrial water systems, e.g., closed loop water systems, to water, renders them highly susceptible to corrosion. Unlike pure aluminum and aluminum-silicon alloys, which have been used conventionally in closed loop water systems, high strength aluminum alloys are more vulnerable to corrosion attack.

Consequently, the advantages of using high strength aluminum alloys are offset by the disadvantage of their increased vulnerability to corrosion. Additionally, certain corrosion standards must be met in order to use high strength aluminum alloys in industrial water systems. Thus, there remains a need for products, and methods of using products, which inhibit the corrosion of high strength aluminum alloys and other corrosion sensitive metals sufficiently to meet the corrosion standards required for industrial water systems. The present invention provides such products and methods of using them to inhibit corrosion in industrial systems. These and other advantages of the invention, as well as additional inventive features, will be apparent from the description of the invention provided herein.

### BRIEF SUMMARY OF THE INVENTION

The present invention provides a product for inhibiting corrosion in a closed loop industrial water system containing a corrosion sensitive metal, which product includes a carboxylic acid-based corrosion inhibitor in an amount sufficient to provide a concentration of at least about 1,000 ppm of the carboxylic acid-based corrosion inhibitor in the system. In one embodiment, the product includes a carboxylic acid-based corrosion inhibitor which includes a C₄₋₁₂ aliphatic monobasic acid, a C₄₋₁₂ aliphatic dibasic acid, a salt thereof, or a combination thereof; an azole-based corrosion inhibitor in an amount sufficient to provide a concentration of at least about 20 ppm of the azole-based corrosion inhibitor in the system; a nitrate-based corrosion inhibitor in an amount sufficient to provide a concentration of at least about 50 ppm of the nitrate-based corrosion inhibitor in the system; and water, wherein the product is substantially free of alkyl alcohols and alkylene glycols.

The present invention also provides a method of inhibiting corrosion of a corrosion sensitive metal in a closed loop industrial water system, which method includes treating water in the system with a corrosion inhibiting-effective amount of a combination of a carboxylic acid-based corrosion inhibitor comprising a C₄₋₁₂ aliphatic monobasic acid, a C₄₋₁₂ aliphatic dibasic acid, a salt thereof, or a combination thereof; an azole-based corrosion inhibitor; and a nitrate-based corrosion inhibitor, to provide a treated water, wherein the combination is substantially free of alkyl alcohols and alkylene glycols.

The present invention further provides a product (e.g., a water treatment composition) comprising from about 25 wt. % to about 75 wt. % of a carboxylic acid-based corrosion inhibitor as described herein, from about 0.5 wt. % to about 5 wt. % of an azole-based corrosion inhibitor as described herein, about 0.5 wt. % to about 10 wt. % of a nitrate-based corrosion inhibitor as described herein, and about 25 wt. % to about 75 wt. % water. In some embodiments, this product is substantially free of alkyl alcohols and alkylene glycols.

### BRIEF DESCRIPTION OF THE DRAWINGS

FIG. 1 is a bar graph depicting the coupon corrosion rate (mpy) of aluminum alloy Al 7075, galvanic aluminum, copper, galvanic copper, and mild steel immersed in recirculated treated synthetic water of a closed loop system.

FIG. 2 depicts coupons of aluminum alloy Al 7075, galvanic aluminum, copper, galvanic copper, and mild steel, which were immersed in recirculated treated synthetic water of a closed loop system.

FIG. 3 is a bar graph depicting the coupon corrosion rate (mpy) of aluminum alloy Al 7075, immersed in (i) recirculated treated synthetic water of an open loop system (Sample 1 and Sample 2) or (ii) recirculated untreated synthetic water of an open loop system (Control), measured using Linear Polarization Resistance (LPR) analysis.

### DETAILED DESCRIPTION OF THE INVENTION

The present invention provides a product for inhibiting corrosion in a closed loop industrial water system containing a corrosion sensitive metal, which product includes a carboxylic acid-based corrosion inhibitor in an amount sufficient/effective to provide a concentration of at least about 1,000 ppm of the carboxylic acid-based corrosion inhibitor in the system. The carboxylic acid-based corrosion inhibitor preferably includes a C₄₋₁₂ aliphatic monobasic acid, a C₄₋₁₂ aliphatic dibasic acid, a salt thereof, or a combination thereof. The product of the invention may further include an azole-based corrosion inhibitor in an amount sufficient/effective to provide a concentration of at least about 20 ppm of the azole-based corrosion inhibitor in the system; a nitrate-based corrosion inhibitor in an amount sufficient to provide a concentration of at least about 50 ppm of the nitrate-based corrosion inhibitor in the system; and water. Preferably, the product of the invention is substantially free of alkyl alcohols and alkylene glycols.

The carboxylic acid-based corrosion inhibitor generally includes a C₄₋₁₂ aliphatic monobasic acid, a C₄₋₁₂ aliphatic dibasic acid, a salt thereof, or a combination thereof. In some embodiments, the carboxylic acid-based corrosion inhibitor includes a C₄₋₁₂ aliphatic monobasic acid or a salt thereof. In some embodiments, the carboxylic acid-based corrosion inhibitor comprises a C₄₋₁₂ aliphatic dibasic acid or a salt thereof. For example, the carboxylic acid-based corrosion inhibitor may include butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, a salt thereof, or a combination thereof.

In certain embodiments, the carboxylic acid-based corrosion inhibitor includes a combination of two or more of butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, or a salt thereof. In certain embodiments, the carboxylic acid component includes adipic acid, sebacic acid, 2-ethylhexanoic acid, butanoic acid, a salt thereof, or a combination thereof. For example, the carboxylic acid-based corrosion inhibitor may include:

a combination of adipic acid or salt thereof, and sebacic acid or salt thereof;

a combination of adipic acid or salt thereof, and 2-ethylhexanoic acid or salt thereof

a combination of adipic acid or salt thereof, and butanoic acid or salt thereof;

a combination of 2-ethylhexanoic acid or salt thereof, and sebacic acid or salt thereof;

a combination of butanoic acid or salt thereof, and sebacic acid or salt thereof; or

a combination of 2-ethylhexanoic acid or salt thereof, and butanoic acid or salt thereof.

The product of the invention preferably includes the carboxylic acid-based corrosion inhibitor in an amount sufficient to provide a concentration of at least about 1,000 ppm (e.g., at least about 1,250 ppm, at least about 1,500 ppm, at least about 1,750 ppm, or at least about 2,000 ppm) of the carboxylic acid-based corrosion inhibitor in the system. The product of the invention (e.g., as packaged or in the form of a composition) accordingly may include the carboxylic acid-based corrosion inhibitor in any amount so long as the system to be treated achieves a concentration of at least about 1,000 ppm of the carboxylic acid-based corrosion inhibitor. In some embodiments, the amount of the carboxylic acid-based corrosion inhibitor in the product of the invention is sufficient to provide a concentration of from about 1,000 ppm to about 20,000 ppm (e.g., from about 1,000 ppm to about 15,000 ppm, from about 1,000 ppm to about 10,000 ppm, from about 1,250 ppm to about 20,000 ppm, from about 1,250 ppm to about 15,000 ppm, from about 1,250 ppm to about 10,000 ppm, from about 1,500 ppm to about 20,000 ppm, from about 1,500 ppm to about 15,000 ppm, from about 1,500 ppm to about 10,000 ppm, from about 1,750 ppm to about 20,000 ppm, from about 1,750 ppm to about 15,000 ppm, from about 1,750 ppm to about 10,000 ppm, from about 2,000 ppm to about 20,000 ppm, from about 2,000 ppm to about 15,000 ppm, or from about 2,000 ppm to about 10,000 ppm) of the carboxylic acid-based corrosion inhibitor in the system.

The corrosion inhibiting product of the invention preferably further includes an azole-based corrosion inhibitor. As used herein, “azole-based corrosion inhibitor” refers to any chemical compound that includes an azole moiety and inhibits corrosion. Examples of azole-based corrosion inhibitors include, but are not limited to, benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CBT), tetrahydrotolyltriazole (THT), a halogen resistant azole (HRA, e.g., chlorobenzotriazole or chlorotolyltriazole), salts thereof, and combinations thereof.

The product in the invention preferably includes an azole-based corrosion inhibitor in an amount sufficient to provide a concentration of at least about 20 ppm (e.g., at least about 30 ppm, at least about 40 ppm, at least about 50 ppm, or at least about 100 ppm) of the azole-based corrosion inhibitor in the system. The product of the invention (e.g., as packaged or in the form of a composition) accordingly may include the azole-based corrosion inhibitor in any amount so long as the system to be treated achieves a concentration of at least about 20 ppm of the azole-based corrosion inhibitor in the system. In some embodiments, the amount of the azole-based corrosion inhibitor is sufficient to provide a concentration of from about 20 ppm to about 1,000 ppm (e.g., from about 20 ppm to about 750 ppm, from about 20 ppm to about 500 ppm, from about 20 ppm to about 250 ppm, from about 30 ppm to about 1,000 ppm, from about 30 ppm to about 750 ppm, from about 30 ppm to about 500 ppm, from about 30 ppm to about 250 ppm, from about 40 ppm to about 1,000 ppm, from about 40 ppm to about 750 ppm, from about 40 ppm to about 500 ppm, from about 40 ppm to about 250 ppm, from about 50 ppm to about 1,000 ppm, from about 50 ppm to about 750 ppm, from about 50 ppm to about 500 ppm, from about 50 ppm to about 250 ppm, from about 100 ppm to about 1,000 ppm, from about 100 ppm to about 750 ppm, from about 100 ppm to about 500 ppm, or from about 100 ppm to about 250 ppm) of the azole-based corrosion inhibitor in the system.

The corrosion product inhibiting preferably further includes a nitrate-based corrosion inhibitor. As used herein, “nitrate-based corrosion inhibitor” refers to any chemical compound that includes a nitrate moiety or ion and inhibits corrosion. Examples of nitrate-based corrosion inhibitors include, but are not limited to, lithium nitrate, sodium nitrate, potassium nitrate, magnesium nitrate, calcium nitrate, or a combination thereof.

The product in the invention preferably includes a nitrate-based corrosion inhibitor in an amount sufficient to provide a concentration of at least about 50 ppm (e.g., at least about 60 ppm, at least about 70 ppm, at least about 80 ppm, at least about 90 ppm, or at least about 100 ppm or greater) of the nitrate-based corrosion inhibitor in the system. In some embodiments, the product (e.g., as packaged or in the form of a composition) may include the nitrate-based corrosion inhibitor in any amount so long as the system to be treated achieves a concentration of at least about 50 ppm of the nitrate-based corrosion inhibitor in the system. For example, the amount of the nitrate-based corrosion inhibitor in the product of the invention may be sufficient to provide a concentration of from about 50 ppm to about 1,000 ppm (e.g., from about 50 ppm to about 750 ppm, from about 50 ppm to about 500 ppm, from about 50 ppm to about 250 ppm, from about 100 ppm to about 1,000 ppm, from about 100 ppm to about 750 ppm, from about 100 ppm to about 500 ppm, or from about 100 ppm to about 250 ppm) of the nitrate-based corrosion inhibitor in the system.

In some embodiments, the corrosion inhibiting product of the invention further includes at least one scale inhibitor. The scale inhibitor may include any suitable scale inhibitor, including scale inhibitors which are known in the art. For example, the scale inhibitor may include one or more polymers that include one or more monomeric units derived from maleic acid, maleic anhydride, (methyl)acrylic acid, (methyl)acrylamide, alkyl epoxy carboxylate, aspartic acid, hydroxypropylacrylate, 2-acrylamido-2-methyl propane sulfonate, sulfonated styrene, tertiary butyl acrylamide, aminomethyl sulfonate, salts thereof, or a combination thereof. Thus, the corrosion inhibiting product of the invention may further include, for example, polymaleic acid, poly(methyl)acrylic acid, polyepoxy succinic acid (PESA), poly-2-acrylamido-2-methyl propane sulfonate, polyaspartic acid (PASP), salts thereof, or a combination thereof. In some embodiments, the scale inhibitor used in the product of the invention includes a polymer comprising (methyl)acrylic acid, 2-acrylamido-2-methyl propane sulfonate, a salt thereof, or a combination thereof.

The scale inhibitor used in the product of the invention may be present in any suitable amount. In some embodiments, the product comprises at least one scale inhibitor in an amount sufficient to provide a concentration of at least about 1 ppm (e.g., at least about 10 ppm, at least about 25 ppm, or at least about 50 ppm) of the scale inhibitor in the system. For example, the product of the invention (e.g., as packaged or in the form of a composition) may include at least one scale inhibitor in any amount so long as the system to be treated achieves a concentration of at least about 1 ppm of the scale inhibitor in the system. In certain embodiments, the amount of scale inhibitor is sufficient to provide a concentration of from about 1 ppm to about 2,000 ppm (e.g., from about 1 ppm to about 1,000 ppm, from about 1 ppm to about 500 ppm, from about 10 ppm to about 2,000 ppm, from about 10 ppm to about 1,000 ppm, from about 10 ppm to about 500 ppm, from about 25 ppm to about 2,000 ppm, from about 25 ppm to about 1,000 ppm, from about 25 ppm to about 500 ppm, from about 50 ppm to about 2,000 ppm, from about 50 ppm to about 1,000 ppm, or from about 50 ppm to about 500 ppm) of scale inhibitor in the system.

In some embodiments, the corrosion inhibiting product of the invention further includes at least one buffer. The buffer used in the product of the invention may include any suitable buffer, including one or more buffers that are known in the art. For example, the buffer may include an inorganic acid and/or salt thereof, e.g., sulfates, bisulfites, hydroxides, halides, etc., an organic acid and/or salt thereof, and/or an organic base, e.g., a primary amine, a secondary amine, or a tertiary amine. In some embodiments, the buffer includes a primary amine, a secondary amine, a tertiary amine, an alkali metal hydroxide, an alkali metal sulfate, an alkali metal sulfite, a salt thereof, or a combination of one or more of the foregoing. Examples of buffers include, but are not limited to, triethanolamine, morpholine, diethanolamine, ethanolamine, lithium hydroxide, sodium hydroxide, potassium hydroxide, sodium sulfate, sodium sulfite, salts thereof, and suitable combinations thereof.

Any suitable amount of buffer may be used in the product of the invention. In some embodiments, the product of the invention comprises at least one buffer in an amount sufficient to provide a concentration of at least about 10 ppm (e.g., at least about 25 ppm, at least about 50 ppm, or at least about 100 ppm) of the at least one buffer in the system. For example, the product of the invention (e.g., as package or in the form of a composition) may include one or more buffers in any amount so long as the system to be treated achieves a concentration of at least about 10 ppm of buffer in the system. In certain embodiments, the amount of buffer is sufficient to provide a concentration of from about 10 ppm to about 20,000 ppm (e.g., from about 10 ppm to about 15,000 ppm, from about 10 ppm to about 10,000 ppm, from about 25 ppm to about 20,000 ppm, from about 25 ppm to about 15,000 ppm, from about 25 ppm to about 10,000 ppm, from about 500 ppm to about 20,000 ppm, from about 50 ppm to about 15,000 ppm, from about 50 ppm to about 10,000 ppm, from about 100 ppm to about 20,000 ppm, from about 100 ppm to about 15,000 ppm, or from about 100 ppm to about 10,000 ppm) of buffer in the system.

As used herein, the phrase “salt thereof” is intended to include salts derived from the parent compound which contains a basic or acidic moiety. Generally, such salts can be prepared by reacting the acid or base form of a compound with an appropriate base or acid, respectively, in water or in an organic solvent, or in a mixture of the two. For example, salts may include one or more salts of an inorganic acid (e.g., hydrochloric acid, sulfuric acid, phosphoric acid, or hydrobromic acid) and/or an organic acid (e.g., oxalic acid, malonic acid, citric acid, fumaric acid, lactic acid, malic acid, succinic acid, tartaric acid, acetic acid, trifluoroacetic acid, gluconic acid, ascorbic acid, methylsulfonic acid, or benzylsulfonic acid), with an inorganic base (e.g., sodium hydroxide, potassium hydroxide, calcium hydroxide, magnesium hydroxide, or ammonium hydroxide) and/or or an organic base (e.g., methylamine, diethylamine, triethylamine, triethanolamine, or ethylenediamine). Salts also may include, e.g., salts of alkali metals (e.g., sodium or potassium), alkaline earth metals (e.g., calcium), and ammonia.

In some embodiments, the corrosion inhibiting product of the invention further includes a carrier. The carrier may include any suitable component that, for example, increases the miscibility of the water treatment composition in water. For example, the carrier may include solvents such as, e.g., water and/or a water-miscible co-solvent such as, for example, acetone, formamide, dimethyl formamide, or a combination thereof, and possibly acidic co-solvents such as, e.g., acetic acid, formic acid, etc., or alkaline co-solvents such as, e.g., triethyl amine.

The product of the invention is preferably substantially free of alkyl alcohols and alkylene glycols. In some embodiments, the product of the invention contains no alkyl alcohols or alkylene glycols, or undetectable levels of alkyl alcohols and alkylene glycols. However, it is possible that impurities in the components or in the water or treated water may contribute trace quantities of alkyl alcohols and alkylene glycols to the system. Accordingly, the possible presence of low concentrations of alkyl alcohols or alkylene glycols in the system is contemplated, e.g., of about 100 ppb or less, e.g., about 50 ppb or less, about 10 ppb or less, or about 1 ppb or less. As used herein, the term “alkyl alcohols” refers generally to C₁₋₁₀ alcohols (e.g., methanol, ethanol, propanol, butanol, etc.), but not necessarily more complex or functionalized compounds with an alcohol functional group such as ethanolamines. As used herein, the term “alkylene glycols” refers to generally to glycol-based compounds, e.g., ethylene glycol, propylene glycol, and the like, and combinations thereof.

In some embodiments, the product of the invention is substantially free of borate and/or molybdate. In such embodiments, the product of the invention preferably contains no borate or molybdate, or undetectable amounts borate and molybdate. However, it is possible that impurities in the components or in the water or treated water may contribute trace quantities of borate and/or molybdate to the system. Accordingly, the possibility of low concentrations of borate and/or molybdate in the system is contemplated, e.g., of about 100 ppb or less, e.g., about 50 ppb or less, about 10 ppb or less, or about 1 ppb or less.

In some embodiments, the product of the invention is substantially free of nitrite and/or phosphate. In such embodiments, the product of the invention preferably contains no nitrite or phosphate, or undetectable amounts of nitrite and phosphate. However, it is possible that impurities in the components or in the water or treated water may contribute trace quantities of nitrite and/or phosphate to the system. Accordingly, the possible presence of low concentrations of nitrite and/or phosphate in the system is contemplated, e.g., of about 100 ppb or less, e.g., about 50 ppb or less, about 10 ppb or less, or about 1 ppb or less.

In some embodiments, the product of the invention, which is to be added to an industrial water system, may be supplied, for example, as a one-package system comprising the carboxylic acid-based corrosion inhibitor, the azole-based corrosion inhibitor, the nitrate-based corrosion inhibitor, and any further optional components. Alternatively, the product of the invention may be supplied as a two-package system, a three-package system, a four-package system, a five-package system, a six-package system, or as a multi-component system with more than six packages, comprising the carboxylic acid-based corrosion inhibitor, the azole-based corrosion inhibitor, the nitrate-based corrosion inhibitor, and/or any further optional components that may be desirable to include as additives. In some embodiments, a multi-component system may allow for the adjustment of relative amounts of the carboxylic acid-based corrosion inhibitor, the azole-based corrosion inhibitor, the nitrate-based corrosion inhibitor, and any further optional components by changing the blending ratio of the components. Various methods may be employed to utilize such a multi-package system. For example, the components may pre-mixed at the point-of use, or the components may be delivered to the industrial water system individually or together using the same mechanism of addition or using different mechanisms of addition. The components may be delivered sequentially or at the same time. As used herein, “point-of-use” refers to the point at which the water treatment product is introduced to the industrial water system.

If desired, the components of the product of the invention may be delivered to the point-of-use independently of each other, e.g., separately but simultaneously or one at a time, such that the components are mixed together by way of their addition to the industrial process. Alternative, one or more of the components of the product may be combined/mixed together before delivery to the point-of-use, e.g., shortly or immediately before delivery to the point-of-use, or the combined/mixed components may be stored together as a composition which may be delivered to a facility for point-of-use application. The term “immediately before delivery to the point-of-use” as used herein refers to temporal proximity, e.g., wherein the components are combined and/or mixed, e.g., about 5 minutes or less before delivery to the point-of-use, for example, about 4 minutes or less, about 3 minutes or less, about 2 minutes or less, about 1 minute or less, about 45 seconds or less, about 30 seconds or less, or about 10 seconds or less prior to being added in mixed form, or simultaneously delivering the components, at the point-of-use. The term “immediately before deliver to the point-of-use” also refers to distance proximity, e.g., wherein the components are combined within a distance of 5 m from the point-of-use, such as within a distance of 1 m from the point-of-use or even within a distance 10 cm of the point-of-use (e.g., within 1 cm of the point-of-use).

If desired, the product of the invention may be provided as a concentrate intended to be diluted with an appropriate amount of water or other carrier prior to use, or diluted with the appropriate amount of water at the point-of-use, which may include the entire volume of industrial water to be treated in the system. In such an embodiment, the water treatment product concentrate may include the components of the water treatment product in amounts such that, upon dilution of the concentrate with an appropriate amount of water, each component of the water treatment product will be present in the industrial water system in a concentration that is within the range needed for each component to serve its intended purpose. For example, the carboxylic acid-based corrosion inhibitor, the azole-based corrosion inhibitor, the nitrate-based corrosion inhibitor, and any further optional components may each be present in the concentrate in any concentration or amount needed for each component to achieve the final concentration in the system needed to serve its intended purpose in the system. Thus, for instance, the product may be formulated as a concentrate with each component an amount sufficient to achieve its desired concentration in a specified volume of an industrial water system so that each component may serve its intended purpose in the support of inhibiting corrosion.

In some embodiments, the product for inhibiting corrosion exists as a single water treatment composition, i.e., a single composition to be added to the industrial water system to treat the water used in the system. The product of the invention may include any suitable amount of carboxylic acid-based corrosion inhibitor, azole-based corrosion inhibitor, nitrate-based corrosion inhibitor, and any further optional components. In some embodiments, the product of the invention is a water treatment composition comprising from about 25 wt. % to about 75 wt. % (e.g., from about 25 wt. % to about 70 wt. %, from about 25 wt. % to about 60 wt. %, from about 25 wt. % to about 50 wt. %, from about 30 wt. % to about 75 wt. %, from about 30 wt. % to about 70 wt. %, from about 30 wt. % to about 60 wt. %, or from about 30 wt. % to about 50 wt. %) of the carboxylic acid-based corrosion inhibitor, from about 0.5 wt. % to about 5 wt. % (e.g., from about 0.5 wt. % to about 4 wt. %, from about 0.5 wt. % to about 3 wt. %, or from about 0.5 wt. % to about 2.5 wt. %) of the azole-based corrosion inhibitor, from about 0.5 wt. % to about 10 wt. % (e.g., from about 0.5 wt. % to about 7.5 wt. %, from about 0.5 wt. % to about 5 wt. %, from about 1 wt. % to about 10 wt. %, from about 1 wt. % to about 7.5 wt. %, or from about 1 wt. % to about 5 wt. %) of the nitrate-based corrosion inhibitor, and about 25 wt. % to about 75 wt. % (e.g., from about 25 wt. % to about 70 wt. %, from about 25 wt. % to about 60 wt. %, from about 25 wt. % to about 50 wt. %, from about 30 wt. % to about 75 wt. %, from about 30 wt. % to about 70 wt. %, from about 30 wt. % to about 60 wt. %, from about 30 wt. % to about 50 wt. %) water. In certain embodiments, the water treatment composition further comprises from about 0.01 wt. % to about 1 wt. % (e.g., from about 0.01 wt. % to about 0.5 wt. %, from about 0.05 wt. % to about 1 wt. %, from about 0.5 wt. % to about 0.5 wt. %, from about 0.1 wt. % to about 1 wt. %, or from about 0.1 wt. % to about 0.5 wt. %) of a scale inhibitor and/or from about 1 wt. % to about 10 wt. % (e.g., from about 1 wt. % to about 7.5 wt. %, from about 1 wt. % to about 5 wt. %, from about 2 wt. % to about 10 wt. %, from about 2 wt. % to about 7.5 wt. %, from about 2 wt. % to about 5 wt. %, from about 2.5 wt. % to about 10 wt. %, from about 2.5 wt. % to about 7.5 wt. %, or from about 2.5 wt. % to about 5 wt. %) of buffer. Thus, the water treatment composition of the invention may include, e.g., any combination of these components in any amount described herein.

The present invention further provides a method of inhibiting corrosion of a corrosion sensitive metal in a closed loop industrial water system, which method includes treating water in the system with a corrosion inhibiting-effective amount of a combination of a carboxylic acid-based corrosion inhibitor comprising a C₄₋₁₂ aliphatic monobasic acid, a C₄₋₁₂ aliphatic dibasic acid, a salt thereof, or a combination thereof; an azole-based corrosion inhibitor; and a nitrate-based corrosion inhibitor, to provide a treated water, wherein the combination is preferably substantially free of alkyl alcohols and alkylene glycols. The carboxylic acid-based corrosion inhibitor, azole-based corrosion inhibitor, and/or nitrate-based corrosion inhibitor each may be added to the water, e.g., of an industrial water system, separately. Alternatively, the carboxylic acid-based corrosion inhibitor, azole-based corrosion inhibitor, and/or nitrate-based corrosion inhibitor may be added to the water, e.g., of an industrial water system, as a single composition.

As used herein, “industrial water system” means any system that circulates water as part of an industrially applicable process. Non-limiting examples of industrial water systems include cooling systems, boiler systems, heating systems, membrane systems, paper making processes, or any other systems that circulate water as part of an industrial application. In certain embodiments, the industrial water system is a cooling system such as, for example, an open loop cooling system, a closed loop cooling system, a passivation cooling system, or a combination thereof.

As used herein, “water” refers to any substance that includes water as a primary ingredient. Water may include, for example, purified water, tap water, fresh water, recycled water, brine, steam, and/or any aqueous solution, or aqueous blend.

The components of the product of the invention (e.g., in the form of a water treatment composition or water treatment combination) of are intended to promote inhibition of corrosion of a metal surface that may come into contact with water in an industrial water system. In some embodiments, the components of the product of the invention (e.g., in the form of a water treatment composition or water treatment combination) may be contacted with a metal surface by immersion, spraying, or other coating techniques. In other embodiments, the components of the water treatment product (e.g., water treatment composition or water treatment combination) may be introduced into the water of the industrial water system by any conventional method and, if desired, may be fed into the industrial water system on either a periodic or continuous basis.

As used herein, “metal” refers to any metal or metal alloy including, but not limited to, stainless steel, alloy steel, galvanized steel, tool steel, mild steel, aluminum, brass, bronze, iron, or copper. In some embodiments, the metal comprises an aluminum alloy 7XXX series, an aluminum alloy 2XXX series, an aluminum alloy 6XXX, a cast aluminum alloy 3XX, a cast aluminum alloy 4XX, a cast aluminum alloy 5XX, a mild steel, copper, or a combination thereof. In certain embodiments, the metal comprises aluminum such as a high strength aluminum alloy. High strength aluminum alloys have a wide-range of applications, including manufacturing applications such as being utilized as injection mold and semiconductor tools. The high strength aluminum alloy can be any suitable high strength aluminum alloy including those which are known to those skilled in the art. For example, the high strength aluminum alloy can be an aluminum alloy 7XXX series, an aluminum alloy 2XXX series, an aluminum alloy 6XXX, a cast aluminum alloy 3XX, a cast aluminum alloy 4XX, a cast aluminum alloy 5XX, or a combination thereof.

The water treated according to the invention may include from about 1,000 ppm to about 20,000 ppm of the carboxylic acid-based corrosion inhibitor, e.g., from about 1,000 ppm to about 15,000 ppm, from about 1,000 ppm to about 10,000 ppm, from about 1,250 ppm to about 20,000 ppm, from about 1,250 ppm to about 15,000 ppm, from about 1,250 ppm to about 10,000 ppm, from about 1,500 ppm to about 20,000 ppm, from about 1,500 ppm to about 15,000 ppm, from about 1,500 ppm to about 10,000 ppm, from about 1,750 ppm to about 20,000 ppm, from about 1,750 ppm to about 15,000 ppm, from about 1,750 ppm to about 10,000 ppm, from about 2,000 ppm to about 20,000 ppm, from about 2,000 ppm to about 15,000 ppm, or from about 2,000 ppm to about 10,000 ppm of the carboxylic acid-based corrosion inhibitor. In certain embodiments, the treated water includes from about 1,000 ppm to about 10,000 ppm of the carboxylic acid-based corrosion inhibitor. In some embodiments, the treated water includes from about 2,000 ppm to about 10,000 ppm of the carboxylic acid-based corrosion inhibitor

The water treated according to the invention also may include from about 20 ppm to about 1,000 ppm of the azole-based corrosion inhibitor, e.g., from about 20 ppm to about 750 ppm, from about 20 ppm to about 500 ppm, from about 20 ppm to about 250 ppm, from about 30 ppm to about 1,000 ppm, from about 30 ppm to about 750 ppm, from about 30 ppm to about 500 ppm, from about 30 ppm to about 250 ppm, from about 40 ppm to about 1,000 ppm, from about 40 ppm to about 750 ppm, from about 40 ppm to about 500 ppm, from about 40 ppm to about 250 ppm, from about 50 ppm to about 1,000 ppm, from about 50 ppm to about 750 ppm, from about 50 ppm to about 500 ppm, from about 50 ppm to about 250 ppm, from about 100 ppm to about 1,000 ppm, from about 100 ppm to about 750 ppm, from about 100 ppm to about 500 ppm, or from about 100 ppm to about 250 ppm of the azole-based corrosion inhibitor. In certain embodiments, the treated water includes from about 20 ppm to about 500 ppm of the azole-based corrosion inhibitor. In some embodiment, the treated water includes from about 20 ppm to about 250 ppm of the azole-based corrosion inhibitor.

The water treated according to the invention further may include from about 50 ppm to about 1,000 ppm of the nitrate-based corrosion inhibitor, e.g., from about 50 ppm to about 750 ppm, from about 50 ppm to about 500 ppm, from about 50 ppm to about 250 ppm, from about 100 ppm to about 1,000 ppm, from about 100 ppm to about 750 ppm, from about 100 ppm to about 500 ppm, or from about 100 ppm to about 250 ppm of the nitrate-based corrosion inhibitor. In certain embodiments, the treated water includes from about 50 ppm to about 500 ppm of the nitrate-based corrosion inhibitor. In some embodiments, the treated water comprises from about 50 ppm to about 250 ppm of the nitrate-based corrosion inhibitor.

In some embodiments, the method of the invention further includes treating the water (e.g., water of the industrial water system) with at least one scale inhibitor. Accordingly, the treated water may include from about 1 ppm to about 2,000 ppm of the scale inhibitor, e.g., from about 1 ppm to about 1,000 ppm, from about 1 ppm to about 500 ppm, from about 10 ppm to about 2,000 ppm, from about 10 ppm to about 1,000 ppm, from about 10 ppm to about 500 ppm, from about 25 ppm to about 2,000 ppm, from about 25 ppm to about 1,000 ppm, from about 25 ppm to about 500 ppm, from about 50 ppm to about 2,000 ppm, from about 50 ppm to about 1,000 ppm, or from about 50 ppm to about 500 ppm of the scale inhibitor. In certain embodiments, the treated water includes from about 1 ppm to about 500 ppm of the scale inhibitor.

In some embodiments, the method of the invention further includes treating water, e.g., of an industrial water system, with at least one buffer. Accordingly, the treated water may include from about 10 ppm to about 20,000 ppm of at least one buffer, e.g., from about 10 ppm to about 15,000 ppm, from about 10 ppm to about 10,000 ppm, from about 25 ppm to about 20,000 ppm, from about 25 ppm to about 15,000 ppm, from about 25 ppm to about 10,000 ppm, from about 500 ppm to about 20,000 ppm, from about 50 ppm to about 15,000 ppm, from about 50 ppm to about 10,000 ppm, from about 100 ppm to about 20,000 ppm, from about 100 ppm to about 15,000 ppm, or from about 100 ppm to about 10,000 ppm. In certain embodiments, the treated water includes from about 10 ppm to about 10,000 ppm of buffer.

The water or treated water of the industrial water system may have any suitable pH. For example, the water or treated water of the industrial water system may have a pH of from about pH 6 to about pH 12. Thus, in certain preferred embodiments, the water or treated water has a pH of from about pH 6 to about pH 12, from about pH 6 to about pH 11, from about pH 6 to about pH 10, from about pH 6 to about pH 9, from about pH 6 to about pH 8, from about pH 7 to about pH 12, from about pH 8 to about pH 12, from about pH 9 to about pH 12, from about pH 7 to about pH 10, or from about pH 8 to about pH 10.

The product and method of the invention may inhibit corrosion caused by any corrosive compound that an industrial water system may include, produce, or come into contact with. For example, the product and method of the invention may inhibit corrosion in the presence of oxidizing halogen compounds including, but not limited to, hypochlorite bleach, chlorine, bromine, hypochlorite, hypobromite, chlorine dioxide, iodine/hypoiodous acid, hypobromous acid, halogenated hydantoins, stabilized versions of hypochlorous or hypobromous acids, or combinations thereof. Alternatively, or additionally, the product and method of the invention may inhibit corrosion in the presence of non-halogen-containing oxidizing biocide including, but not limited to, peroxides (e.g., hydrogen peroxide), persulfates, permanganates, and peracetic acids.

The product and method of the invention are intended to provide a metal, e.g., high strength aluminum alloy, corrosion rate that meets or exceeds industry standards required for industrial water systems, e.g., about 1 mpy or less. In certain embodiments, the product and method of the invention provide a metal (e.g., high strength aluminum alloy) corrosion rate of about 1 mpy or less, e.g., about 0.9 mpy or less, about 0.8 mpy or less, about 0.7 mpy or less, about 0.6 mpy or less, about 0.5 mpy or less, about 0.4 mpy, or about 0.3 mpy or less. In some embodiments, the compositions and methods of the invention provide a metal (e.g., high strength aluminum alloy) corrosion rate of about 0.1 mpy or less, about 0.05 mpy or less, about 0.04 mpy or less, about 0.03 mpy or less, about 0.02 mpy or less, about 0.01 mpy or less, about 0.005 mpy or less, or about 0.002 mpy or less.

In one embodiment, the corrosion inhibiting product of the invention includes sodium 2-ethylhexanoate (e.g., about 20 wt. % to about 40 wt. % or about 25 wt. % to about 35 wt. %), adipic acid (e.g., about 5 wt. % to about 20 wt. % or about 5 wt. % to about 10 wt. %), sodium tolytriazole (e.g., about 0.5 wt. % to about 1.5 wt. %), sodium benzotriazole (e.g., about 0.1 wt. % to about 0.5 wt. %), sodium nitrate (e.g., about 1 wt. % to about 10 wt. % or about 1 wt. % to about 5 wt. %), water (e.g., about 40 wt. % to about 60 wt. % or about 45 wt. % to about 55 wt. %), optionally about 1 wt. % to about 10 wt. % of a buffer (e.g., triethanolamine, diethanolamine, sodium bisulfate, sodium sulfate, sodium hydroxide, or a combination thereof), and optionally about 0.01 wt. % to about 1 wt. % of a scale inhibitor (e.g., acrylic acid/sodium 2-acrylamido-2-methyl propane sulfonate polymer). This product may be formulated as a composition (e.g., a concentrate) containing these components and delivered to, e.g., an industrial water system as a composition, e.g., at the point-of-use, as described herein. Alternatively, this product may be delivered to, e.g., an industrial water system, e.g., at the point-of-use, by delivering each component separately, e.g., simultaneously or one at a time, two at a time, etc., as described herein.

### Embodiments

(1) In embodiment (1) is presented a product for inhibiting corrosion in a closed loop industrial water system containing a corrosion sensitive metal, the product comprising:

a carboxylic acid-based corrosion inhibitor in an amount sufficient to provide a concentration of at least about 1,000 ppm of the carboxylic acid-based corrosion inhibitor in the system, the carboxylic acid-based corrosion inhibitor comprising a C₄₋₁₂ aliphatic monobasic acid, a C₄₋₁₂ aliphatic dibasic acid, a salt thereof, or a combination thereof;

an azole-based corrosion inhibitor in an amount sufficient to provide a concentration of at least about 20 ppm of the azole-based corrosion inhibitor in the system;

a nitrate-based corrosion inhibitor in an amount sufficient to provide a concentration of at least about 50 ppm of the nitrate-based corrosion inhibitor in the system; and

water,

wherein the product is substantially free of alkyl alcohols and alkylene glycols.

(2) In embodiment (2) the product of embodiment (1), wherein the product is substantially free of borate and molybdate.

(3) In embodiment (3) the product of embodiment (1), wherein the carboxylic acid-based corrosion inhibitor comprises a C₄₋₁₂ aliphatic monobasic acid or a salt thereof.

(4) In embodiment (4) the product of embodiment (1), wherein the carboxylic acid-based corrosion inhibitor comprises a C₄₋₁₂ aliphatic dibasic acid or a salt thereof.

(5) In embodiment (5) the product of embodiment (1), wherein the carboxylic acid-based corrosion inhibitor comprises butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, a salt thereof, or a combination thereof.

(6) In embodiment (6) the product of embodiment (1), wherein the carboxylic acid-based corrosion inhibitor comprises a combination of two or more of butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, or a salt thereof.

(7) In embodiment (7) the product of embodiment (1), wherein the carboxylic acid-based corrosion inhibitor comprises adipic acid, sebacic acid, 2-ethylhexanoic acid, butanoic acid, a salt thereof, or a combination thereof.

(8) In embodiment (8) the product of embodiment (1), wherein the carboxylic acid-based corrosion inhibitor comprises:

a combination of adipic acid or salt thereof, and sebacic acid or salt thereof;

a combination of adipic acid or salt thereof, and 2-ethylhexanoic acid or salt thereof

a combination of adipic acid or salt thereof, and butanoic acid or salt thereof;

a combination of 2-ethylhexanoic acid or salt thereof, and sebacic acid or salt thereof;

a combination of butanoic acid or salt thereof, and sebacic acid or salt thereof or

a combination of 2-ethylhexanoic acid or salt thereof, and butanoic acid or salt thereof.

(9) In embodiment (9) the product of any one of embodiments (1)-(8), wherein the amount of carboxylic acid-based corrosion inhibitor is sufficient to provide a concentration of at least about 2,000 ppm of the carboxylic acid-based corrosion inhibitor in the system.

(10) In embodiment (10) the product of any one of embodiments (1)-(8), wherein the amount of carboxylic acid-based corrosion inhibitor is sufficient to provide a concentration of from about 1,000 ppm to about 20,000 ppm of the carboxylic acid-based corrosion inhibitor in the system.

(11) In embodiment (11) the product of any one of embodiments (1)-(8), wherein the amount of carboxylic acid-based corrosion inhibitor is sufficient to provide a concentration of from about 2,000 ppm to about 10,000 ppm of the carboxylic acid-based corrosion inhibitor in the system.

(12) In embodiment (12) the product of any one of embodiments (1)-(11), wherein the azole-based corrosion inhibitor comprises benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CBT), tetrahydrotolyltriazole (THT), a halogen resistant azole (HRA), salts thereof, or a combination thereof.

(13) In embodiment (13) the product of any one of embodiments (1)-(12), wherein the amount of azole-based corrosion inhibitor is sufficient to provide a concentration of from about 20 ppm to about 1,000 ppm of the azole-based corrosion inhibitor in the system.

(14) In embodiment (14) the product of any one of embodiments (1)-(12), wherein the amount of azole-based corrosion inhibitor is sufficient to provide a concentration of from about 20 ppm to about 500 ppm of the azole-based corrosion inhibitor in the system.

(15) In embodiment (15) the product of any one of embodiments (1)-(12), wherein the amount of azole-based corrosion inhibitor is sufficient to provide a concentration of from about 20 ppm to about 250 ppm of the azole-based corrosion inhibitor in the system.

(16) In embodiment (16) the product of any one of embodiments (1)-(15), wherein the nitrate-based corrosion inhibitor comprises lithium nitrate, sodium nitrate, potassium nitrate, magnesium nitrate, calcium nitrate, or a combination thereof.

(17) In embodiment (17) the product of any one of embodiments (1)-(16), wherein the amount of nitrate-based corrosion inhibitor is sufficient to provide a concentration of from about 50 ppm to about 1,000 ppm of the nitrate-based corrosion inhibitor in the system.

(18) In embodiment (18) the product of any one of embodiments (1)-(16), wherein the amount of nitrate-based corrosion inhibitor is sufficient to provide a concentration of from about 50 ppm to about 500 ppm of the nitrate-based corrosion inhibitor in the system.

(19) In embodiment (19) the product of any one of embodiments (1)-(16), wherein the amount of nitrate-based corrosion inhibitor is sufficient to provide a concentration of from about 50 ppm to about 250 ppm of the nitrate-based corrosion inhibitor in the system.

(20) In embodiment (20) the product of any one of embodiments (1)-(19), further comprising at least one scale inhibitor.

(21) In embodiment (21) the product of embodiment (20), wherein the scale inhibitor comprises a polymer comprising one or more monomeric units derived from maleic acid, maleic anhydride, (methyl)acrylic acid, (methyl)acrylamide, alkyl epoxy carboxylate, aspartic acid, hydroxypropylacrylate, 2-acrylamido-2-methyl propane sulfonate, sulfonated styrene, tertiary butyl acrylamide, aminomethyl sulfonate, salts thereof, or a combination thereof.

(22) In embodiment (22) the product of any one of embodiments (1)-(21), further comprising at least one buffer.

(23) In embodiment (23) the product of embodiment (22), wherein the buffer comprises a primary amine, a secondary amine, a tertiary amine, an alkali metal hydroxide, an alkali metal sulfate, an alkali metal sulfite, salts thereof, or a combination thereof.

(24) In embodiment (24) the product of embodiment (22), wherein the buffer comprises triethanolamine, morpholine, diethanolamine, ethanolamine, lithium hydroxide, sodium hydroxide, potassium hydroxide, sodium sulfate, sodium sulfite, salts thereof, or a combination thereof.

(25) In embodiment (25) the product of any one of embodiments (1)-(24), wherein the product is substantially free of nitrite and phosphate.

(26) In embodiment (26) the product of any one of embodiments (1)-(24), wherein the product is substantially free of molybdate, silicate, borate, nitrite, and phosphate.

(27) In embodiment (27) the product of any one of embodiments (1)-(26), wherein the product comprises from about 25 wt. % to about 75 wt. % of the carboxylic acid-based corrosion inhibitor, from about 0.5 wt. % to about 5 wt. % of the azole-based corrosion inhibitor, from about 0.5 wt. % to about 10 wt. % of the nitrate-based corrosion inhibitor, and from about 25 wt. % to about 75 wt. % water.

(28) In embodiment (28) the product of any one of embodiments (1)-(27), wherein the product comprises from about 30 wt. % to about 50 wt. % of the carboxylic acid-based corrosion inhibitor, from about 0.5 wt. % to about 2.5 wt. % of the azole-based corrosion inhibitor, from about 0.5 wt. % to about 5 wt. % of the nitrate-based corrosion inhibitor, and from about 40 wt. % to about 60 wt. % water.

(29) In embodiment (29) the product of embodiment (27) or embodiment (28), wherein the product further comprises from about 0.01 wt. % to about 1 wt. % of the scale inhibitor.

(30) In embodiment (30) the product of any one of embodiments 27-29, wherein the product further comprises from about 1 wt. % to about 10 wt. % of the buffer.

(31) In embodiment (31) is presented a method of inhibiting corrosion of a corrosion sensitive metal in a closed loop industrial water system, the method comprising treating water in the system with a corrosion inhibiting-effective amount of a combination of:

a carboxylic acid-based corrosion inhibitor comprising a C₄₋₁₂ aliphatic monobasic acid, a C₄₋₁₂ aliphatic dibasic acid, a salt thereof, or a combination thereof;

an azole-based corrosion inhibitor; and

a nitrate-based corrosion inhibitor,

to provide a treated water, wherein the combination is substantially free of alkyl alcohols and alkylene glycols.

(32) In embodiment (32) the method of embodiment (31), wherein the treated water comprises at least about 1,000 ppm of the carboxylic acid-based corrosion inhibitor.

(33) In embodiment (33) the method of embodiment (31), wherein the treated water comprises at least about 2,000 ppm of the carboxylic acid-based corrosion inhibitor.

(34) In embodiment (34) the method of embodiment (31), wherein the treated water comprises from about 1,000 ppm to about 20,000 ppm of the carboxylic acid-based corrosion inhibitor.

(35) In embodiment (35) the method of embodiment (31), wherein the treated water comprises from about 2,000 ppm to about 10,000 ppm of the carboxylic acid-based corrosion inhibitor.

(36) In embodiment (36) the method of any one of embodiments (31)-(35), wherein the treated water comprises at least about 20 ppm of the azole-based corrosion inhibitor.

(37) In embodiment (37) the method of any one of embodiments (31)-(35), wherein the treated water comprises from about 20 ppm to about 1,000 ppm of the azole-based corrosion inhibitor.

(38) In embodiment (38) the method of any one of embodiments (31)-(35), wherein the treated water comprises from about 20 ppm to about 500 ppm of the azole-based corrosion inhibitor.

(39) In embodiment (39) the method of any one of embodiments (31)-(35), wherein the treated water comprises from about 20 ppm to about 250 ppm of the azole-based corrosion inhibitor.

(40) In embodiment (40) the method of any one of embodiments (31)-(39), wherein the treated water comprises at least about 50 ppm of the nitrate-based corrosion inhibitor.

(41) In embodiment (41) the method of any one of embodiments (31)-(39), wherein the treated water comprises from about 50 ppm to about 1,000 ppm of the nitrate-based corrosion inhibitor.

(42) In embodiment (42) the method of any one of embodiments (31)-(39), wherein the treated water comprises from about 50 ppm to about 500 ppm of the nitrate-based corrosion inhibitor.

(43) In embodiment (43) the method of any one of embodiments (31)-(39), wherein the treated water comprises from about 50 ppm to about 250 ppm of the nitrate-based corrosion inhibitor.

(44) In embodiment (44) the method of any one of embodiments (31)-(43), wherein the carboxylic acid-based corrosion inhibitor comprises a C₄₋₁₂ aliphatic monobasic acid or a salt thereof.

(45) In embodiment (45) the method of any one of embodiments (31)-(43), wherein the carboxylic acid-based corrosion inhibitor comprises a C₄₋₁₂ aliphatic dibasic acid or a salt thereof.

(46) In embodiment (46) the method of any one of embodiments (31)-(43), wherein the carboxylic acid-based corrosion inhibitor comprises butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, a salt thereof, or a combination thereof.

(47) In embodiment (47) the method of any one of embodiments (31)-(43), wherein the carboxylic acid-based corrosion inhibitor comprises a combination of two or more of butanoic acid, pentanoic acid, hexanoic acid, heptanoic acid, isoheptanoic acid, octanoic acid, 2-ethylhexanoic acid, nonanoic acid, decanoic acid, undecanoic acid, dodecanoic acid, neodecanoic, maleic acid, fumaric acid, succinic acid, methylmalonic acid, glutaric acid, methylsuccinic acid, adipic acid, 2-methylglutaric acid, phthalic acid, pimelic acid, isophthalic acid, suberic acid, azelaic acid, sebacic acid, undecanedioic acid, dodecanedioic acid, or a salt thereof.

(48) In embodiment (48) the method of any one of embodiments (31)-(43), wherein the carboxylic acid-based corrosion inhibitor comprises adipic acid, sebacic acid, 2-ethylhexanoic acid, butanoic acid, a salt thereof, or a combination thereof.

(49) In embodiment (49) the method of any one of embodiments (31)-(43), wherein the carboxylic acid-based corrosion inhibitor comprises:

a combination of adipic acid or salt thereof, and sebacic acid or salt thereof;

a combination of adipic acid or salt thereof, and 2-ethylhexanoic acid or salt thereof

a combination of adipic acid or salt thereof, and butanoic acid or salt thereof;

a combination of 2-ethylhexanoic acid or salt thereof, and sebacic acid or salt thereof;

a combination of butanoic acid or salt thereof, and sebacic acid or salt thereof or

a combination of 2-ethylhexanoic acid or salt thereof, and butanoic acid or salt thereof.

(50) In embodiment (50) the method of any one of embodiments (31)-(49), wherein the azole-based corrosion inhibitor comprises benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CB T), tetrahydrotolyltriazole (THT), a halogen resistant azole (HRA), salts thereof, or a combination thereof.

(51) In embodiment (51) the method of any one of embodiments (31)-(50), wherein the nitrate-based corrosion inhibitor comprises lithium nitrate, sodium nitrate, potassium nitrate, magnesium nitrate, calcium nitrate, or a combination thereof.

(52) In embodiment (52) the method of any one of embodiments (31)-(51), wherein the carboxylic acid-based corrosion inhibitor, the azole-based corrosion inhibitor, and the nitrate-based corrosion inhibitor are added to the water separately.

(53) In embodiment (53) the method of any one of embodiments (31)-(51), wherein one or more of the carboxylic acid-based corrosion inhibitor, the azole-based corrosion inhibitor, and the nitrate-based corrosion inhibitor are added to the water together as a mixture.

(54) In embodiment (54) the method of any one of embodiments (31)-(53), wherein the method further comprises treating the water with at least one scale inhibitor.

(55) In embodiment (55) the method of embodiment (54), wherein the scale inhibitor is a polymer comprising a monomeric unit derived from maleic acid, maleic anhydride, (methyl)acrylic acid, (methyl)acrylamide, alkyl epoxy carboxylate, aspartic acid, hydroxypropylacrylate, 2-acrylamido-2-methyl propane sulfonate, sulfonated styrene, tertiary butyl acrylamide, aminomethyl sulfonate, salts thereof, or a combination thereof.

(56) In embodiment (56) the method of any one of embodiments (31)-(55), further comprising treating the water with at least one buffer.

(57) In embodiment (57) the method of embodiment (56), wherein the buffer comprises a primary amine, a secondary amine, a tertiary amine, an alkali metal hydroxide, an alkali metal sulfate, an alkali metal sulfite, salts thereof, or a combination thereof.

(58) In embodiment (58) the method of embodiment (56), wherein the buffer comprises triethanolamine, morpholine, diethanolamine, ethanolamine, lithium hydroxide, sodium hydroxide, potassium hydroxide, sodium sulfate, sodium sulfite, salts thereof, or a combination thereof.

(59) In embodiment (59) the method of any one of embodiments (31)-(58), wherein the combination is substantially free of nitrite, molybdate, silicate, borate, and phosphate.

(60) In embodiment (60) the method of any one of embodiments (31)-(59), wherein the industrial water system comprises a cooling system.

(61) In embodiment (61) the method of any one of embodiments (31)-(60), wherein the metal comprises aluminum.

(62) In embodiment (62) the method of any one of embodiments (31)-(60), wherein the metal comprises high strength aluminum alloy.

(63) In embodiment (63) the method of any one of embodiments (31)-(60), wherein the metal comprises an aluminum alloy 7XXX series, an aluminum alloy 2XXX series, an aluminum alloy 6XXX, a cast aluminum alloy 3XX, a cast aluminum alloy 4XX, a cast aluminum alloy 5XX, a mild steel, copper, or a combination thereof.

### EXAMPLES

The following examples further illustrate the invention but, of course, should not be construed as in any way limiting its scope.

### Example 1

This example demonstrates the beneficial corrosion inhibition performance of an exemplary product of the invention.

Carboxylic acid-based corrosion inhibitors adipic acid, sebacic acid, 2-ethylhexanoic acid, and butanoic acid were added to a closed loop system in the amounts specified in Table 1. The closed loop system had a synthetic water matrix having a pH of about 7.3, a conductivity of about 340 μS, a metal alkalinity of about 120 ppm, a chloride ion concentration of about 15 ppm, a sulfate ion concentration of about 25 ppm, and a hardness of about 50 ppm. The treated synthetic water matrix was recirculated in the closed loop system at a temperature of about 10° C. Metal coupons of aluminum alloys Al 1100, Al 7075, and Al 6061 were immersed in the recirculated closed loop system for a period of 90 days, and the corrosion rate was calculated in mils per year (mpy) by measuring the weight of the coupon. The results are summarized in Table 1.

TABLE 1
Corrosion Rate of Aluminum Alloys in
Aqueous Solutions of Carboxylic Acid-
Based Corrosion Inhibitors (1 wt. %)

| Corrosion | Al 1100 | Al 7075 | Al 6061 |
|---|---|---|---|
| Inhibitor (wt. %) | (mpy) | (mpy) | (mpy) |
| adipic acid (1.0) | <0.2 | <0.2 | <0.2 |
| sebacic acid (1.0) | <0.2 | <0.2 | <0.2 |
| 2-ethylhexanoic acid (1.0) | <0.2 | <0.2 | <0.2 |
| butanoic acid (1.0) | <0.1 | <0.1 | <0.2 |
| adipic acid (0.5) and | <0.1 | <0.2 | <0.1 |
| sebacic acid (0.5) | | | |
| adipic acid (0.5) and | <0.1 | <0.2 | <0.1 |
| 2-ethylhexanoic acid (0.5) | | | |
| adipic acid (0.5) and | <0.1 | <0.1 | <0.1 |
| butanoic acid (0.5) | | | |
| sebacic acid (0.5) and | <0.1 | <0.2 | <0.1 |
| 2-ethylhexanoic acid (0.5) | | | |
| sebacic acid (0.5) and | <0.1 | <0.1 | <0.1 |
| butanoic acid (0.5) | | | |
| 2-ethylhexanoic acid (0.5) | <0.1 | <0.1 | <0.1 |
| and butanoic acid (0.5) | | | |

According to industry standards, corrosion rates of 1 mpy or less for aluminum in closed loop recirculating water systems to be negligible or excellent.

As is apparent from the results set forth in Table 1, each of the carboxylic acid-based corrosion inhibitors provide a corrosion rate of less than 0.2 mpy for aluminum alloys Al 1100, Al 7075, and Al 6061. Thus, the corrosion rate of aluminum alloys Al 1100, Al 7075, and Al 6061 in the presence of each of the carboxylic acid-based corrosion inhibitors is considered negligible or excellent.

### Example 2

This example demonstrates the beneficial corrosion inhibition of aluminum, copper, and mild steel exhibited by an exemplary product of the invention.

A closed loop system containing a synthetic water matrix having a pH of about 7.3, a conductivity of about 340 μS, a metal alkalinity of about 120 ppm, a chloride ion concentration of about 15 ppm, a sulfate ion concentration of about 25 ppm, and a hardness of about 50 ppm was treated with a product containing sodium 2-ethylhexanoate (about 30 wt. %), adipic acid sodium salt (about 10 wt. %), sodium tolytriazole (about 0.8 wt. %), sodium benzotriazole (about 0.3 wt. %), and sodium nitrate (about 4 wt. %), and was added to the synthetic water matrix to achieve a concentration of at least about 1,000 ppm of the carboxylic acid-based corrosion inhibitor, a concentration of at least about 20 ppm of the azole-based corrosion inhibitor, and a concentration of at least about 50 ppm of the nitrate-based corrosion inhibitor in the system.

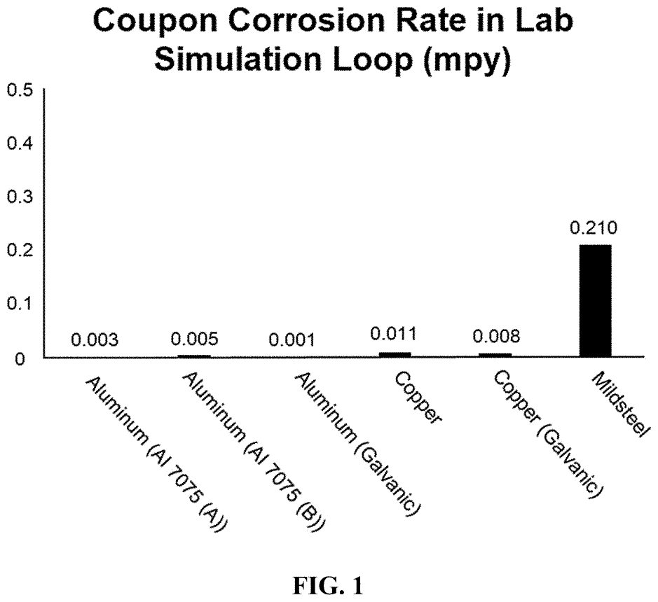

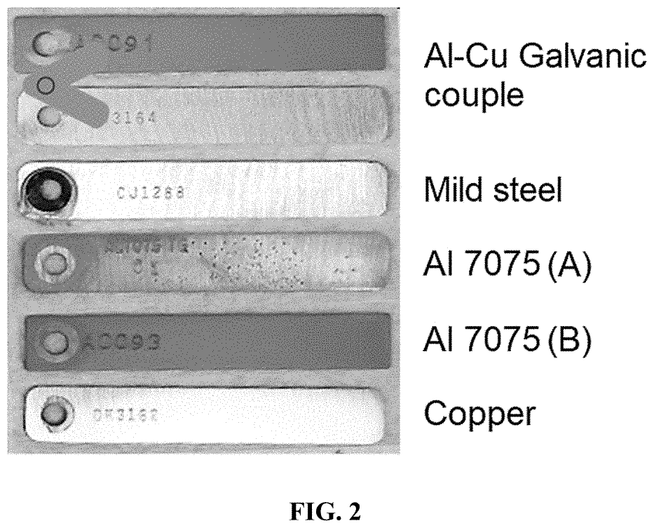

The treated synthetic water matrix was recirculated in the closed loop system at a temperature of about 10° C. Metal coupons of aluminum alloys Al 7075 (A) and Al 7075 (B), galvanic aluminum, copper, galvanic copper, and mild steel were immersed for a period of 90 days in the recirculated treated synthetic water matrix, and the corrosion rate was calculated in mils per year (mpy) by measuring the weight of the coupon. The corrosion rate of the metal coupons is shown in FIG. 1 and the coupons, after exposure to the treated synthetic water matrix for a period of 90 days, are presented in FIG. 2.

According to industry standards, corrosion rates of 1 mpy or less for aluminum, 0.25 mpy or less for copper, and 0.5 mpy or less for steel in closed loop recirculating water systems to be good.

As is apparent from the results set forth in FIGS. 1 and 2, achieving a concentration of at least about 1,000 ppm of the carboxylic acid-based corrosion inhibitor, a concentration of at least about 20 ppm of the azole-based corrosion inhibitor, and a concentration of at least about 50 ppm of the nitrate-based corrosion inhibitor in the closed loop system provides a corrosion rate of less than 0.01 for aluminum, a corrosion rate of less than 0.02 for copper, and less than 0.25 for mild steel. Thus, the corrosion rate of aluminum, copper, and mild steel is negligible or excellent according to industry standards.

### Example 3

This example demonstrates the beneficial corrosion inhibition of aluminum alloy Al 7075 exhibited by an exemplary product of the invention.

A synthetic water matrix having a pH of about 7.3, a conductivity of about 340 μS, a metal alkalinity of about 120 ppm, a chloride ion concentration of about 15 ppm, a sulfate ion concentration of about 25 ppm, and a hardness of about 50 ppm was added to three separate containers labeled Sample 1, Sample 2, and Control. The synthetic water matrix in the containers labeled Sample 1 and Sample 2 was treated with a product containing sodium 2-ethylhexanoate (about 30 wt. %), adipic acid sodium salt (about 10 wt. %), sodium tolytriazole (about 0.8 wt. %), sodium benzotriazole (about 0.3 wt. %), and sodium nitrate (about 4 wt. %). The product was added synthetic water matrix in an amount to achieve a concentration of at least about 1,000 ppm of the carboxylic acid-based corrosion inhibitor in the system, a concentration of at least about 20 ppm of the azole-based corrosion inhibitor, and a concentration of at least about 50 ppm of the nitrate-based corrosion inhibitor in the container.

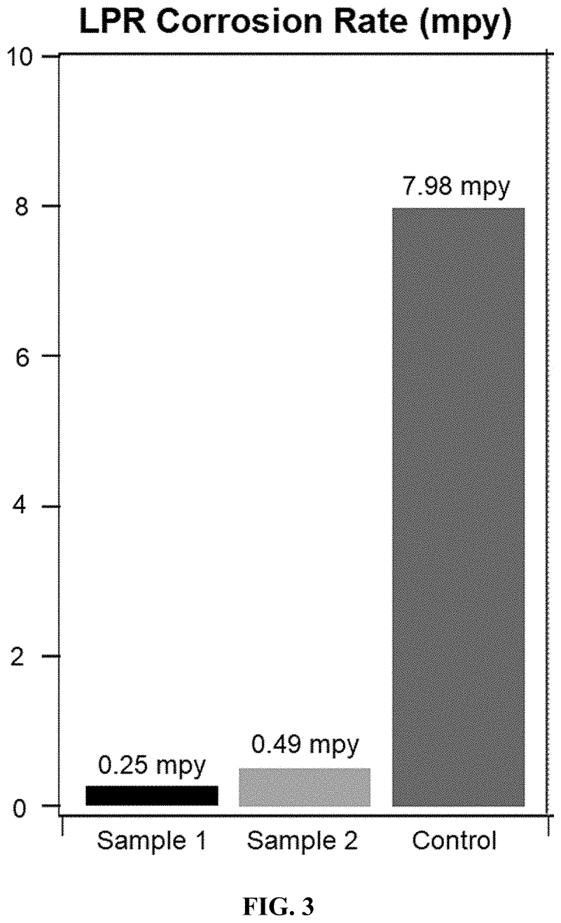

Metal coupons of aluminum alloy Al 7075 were immersed in each of the containers labeled Sample 1, Sample 2, and Control at room temperature (e.g., about 25° C.), and the corrosion rate was measured in mils per year (mpy) using Linear Polarization Resistance (LPR) analysis. The corrosion rate of each of the metal coupons immersed in the containers labeled Sample 1, Sample 2, and Control is shown in FIG. 3.

According to industry standards, corrosion rates of 1 mpy or less for aluminum in closed loop recirculating water systems to be negligible or excellent.

As is apparent from the results set forth in FIG. 3, containers labeled Sample 1 and Sample 2, which were treated with a product comprising a carboxylic acid-based corrosion inhibitor, an azole-based corrosion inhibitor, and a nitrate-based corrosion inhibitor provided a corrosion rate of less than 0.5 mpy for each of the aluminum alloy coupons. In contrast, the container labeled Control, which was not treated, provided a corrosion rate of about 8 mpy for the aluminum alloy coupon. Thus, the water treated with the product of the invention reduced the corrosion rate of aluminum alloy Al 7075 by greater than 10-fold relative to water that has not been treated.

### Example 4

This example provides an exemplary formulation for a product of the invention.

A carboxylic acid-based corrosion inhibitor (i.e., sodium 2-ethylhexanoate and adipic acid sodium salt), an azole-based corrosion inhibitor (i.e., sodium tolytriazole and sodium benzotriazole), a nitrate-based corrosion inhibitor (i.e., sodium nitrate), were combined with other components (e.g., buffers and scale inhibitors) as set forth in Table 2.

TABLE 2
Exemplary Corrosion Inhibitor Formulation

| | Amount |
|---|---|
| Component | (wt. %) |
| water | 78.65645 |
| sodium 2-ethylhexanoate | 7.8682 |
| adipic acid sodium salt | 1.9671 |
| sodium tolytriazole | 0.8193 |
| sodium benzotriazole | 0.2911 |
| sodium nitrate | 3.71 |
| acrylic acid/sodium 2-acrylamido- | 0.1111 |
| 2-methyl propane | |
| sulfonate polymer | |
| triethanolamine | 6.4889 |
| trace additives/byproducts/impurities | 0.0879 |

### Example 5

This example provides an exemplary formulation for a product of the invention.

A carboxylic acid-based corrosion inhibitor (i.e., sodium 2-ethylhexanoate and adipic acid sodium salt), an azole-based corrosion inhibitor (i.e., sodium tolytriazole and sodium benzotriazole), a nitrate-based corrosion inhibitor (i.e., sodium nitrate), were combined with other components (e.g., buffers and scale inhibitors) as set forth in Table 3.

TABLE 3
Exemplary Corrosion Inhibitor Formulation

| | Amount |
|---|---|
| Component | (wt. %) |
| water | 62.8005 |
| sodium 2-ethylhexanoate | 16.8364 |
| adipic acid sodium salt | 8.8548 |
| sodium tolytriazole | 0.8193 |
| sodium benzotriazole | 0.2911 |
| sodium nitrate | 3.71 |
| acrylic acid/sodium 2-acrylamido- | 0.1111 |
| 2-methyl propane | |
| sulfonate polymer | |
| triethanolamine | 6.4889 |
| trace additives/byproducts/impurities | 0.0879 |

### Example 6

This example provides an exemplary formulation for a product of the invention.

A carboxylic acid-based corrosion inhibitor (i.e., sodium 2-ethylhexanoate and adipic acid sodium salt), an azole-based corrosion inhibitor (i.e., sodium tolytriazole and sodium benzotriazole), a nitrate-based corrosion inhibitor (i.e., sodium nitrate), were combined with other components (e.g., buffers and scale inhibitors) as set forth in Table 4.

TABLE 4
Exemplary Corrosion Inhibitor Formulation

| | Amount |
|---|---|
| Component | (wt. %) |
| water | 48.1643 |
| sodium 2-ethylhexanoate | 31.4728 |
| adipic acid sodium salt | 8.8548 |
| sodium tolytriazole | 0.8193 |
| sodium benzotriazole | 0.2911 |
| sodium nitrate | 3.7100 |
| acrylic acid/sodium 2-acrylamido- | 0.1111 |
| 2-methyl propane | |
| sulfonate polymer | |
| triethanolamine | 6.4889 |
| trace additives/byproducts/impurities | 0.0879 |

### Example 7

This example provides an exemplary formulation for a product of the invention.

A carboxylic acid-based corrosion inhibitor (i.e., sodium 2-ethylhexanoate and sebacic acid sodium salt), an azole-based corrosion inhibitor (i.e., sodium tolytriazole and sodium benzotriazole), a nitrate-based corrosion inhibitor (i.e., sodium nitrate), were combined with other components (e.g., buffers and scale inhibitors) as set forth in Table 5.

TABLE 5
Exemplary Corrosion Inhibitor Formulation

| | Amount |
|---|---|
| Component | (wt. %) |
| water | 68.8212 |
| sodium 2-ethylhexanoate | 15.7364 |
| sebacic acid sodium salt | 3.9341 |
| sodium tolytriazole | 0.8193 |
| sodium benzotriazole | 0.2911 |
| sodium nitrate | 3.71 |
| acrylic acid/sodium 2-acrylamido- | 0.1111 |
| 2-methyl propane | |
| sulfonate polymer | |
| triethanolamine | 6.4889 |
| trace additives/byproducts/impurities | 0.0879 |

### Example 8

This example provides an exemplary formulation for a product of the invention.

A carboxylic acid-based corrosion inhibitor (i.e., sodium 2-ethylhexanoate and butanoic acid sodium salt), an azole-based corrosion inhibitor (i.e., sodium tolytriazole and sodium benzotriazole), a nitrate-based corrosion inhibitor (i.e., sodium nitrate), were combined with other components (e.g., buffers and scale inhibitors) as set forth in Table 6.

TABLE 6
Exemplary Corrosion Inhibitor Formulation

| | Amount |
|---|---|
| Component | (wt. %) |
| water | 70.7821 |
| sodium 2-ethylhexanoate | 8.8548 |
| butanoic acid sodium salt | 8.8548 |
| sodium tolytriazole | 0.8193 |
| sodium benzotriazole | 0.2911 |
| sodium nitrate | 3.71 |
| acrylic acid/sodium 2-acrylamido- | 0.1111 |
| 2-methyl propane | |
| sulfonate polymer | |
| triethanolamine | 6.4889 |
| trace additives/byproducts/impurities | 0.0879 |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A product for inhibiting corrosion in a closed loop industrial water system containing a corrosion sensitive metal, the product comprising:
a carboxylic acid-based corrosion inhibitor in an amount sufficient to provide a concentration of at least about 1,000 ppm of the carboxylic acid-based corrosion inhibitor in the system, the carboxylic acid-based corrosion inhibitor comprising a C₄₋₁₂ aliphatic monobasic acid, a C₄₋₁₂ aliphatic dibasic acid, a salt thereof, or a combination thereof;
an azole-based corrosion inhibitor in an amount sufficient to provide a concentration of at least about 20 ppm of the azole-based corrosion inhibitor in the system;
a nitrate-based corrosion inhibitor in an amount sufficient to provide a concentration of at least about 50 ppm of the nitrate-based corrosion inhibitor in the system; and
water,
wherein the product is substantially free of alkyl alcohols and alkylene glycols.

2. The product of claim 1, wherein the carboxylic acid-based corrosion inhibitor comprises adipic acid, sebacic acid, 2-ethylhexanoic acid, butanoic acid, a salt thereof, or a combination thereof.

3. The product of claim 1, wherein the amount of carboxylic acid-based corrosion inhibitor is sufficient to provide a concentration of from about 1,000 ppm to about 20,000 ppm of the carboxylic acid-based corrosion inhibitor in the system.

4. The product of claim 1, wherein the amount of azole-based corrosion inhibitor is sufficient to provide a concentration of from about 20 ppm to about 1,000 ppm of the azole-based corrosion inhibitor in the system.

5. The product of claim 1, wherein the amount of nitrate-based corrosion inhibitor is sufficient to provide a concentration of from about 50 ppm to about 1,000 ppm of the nitrate-based corrosion inhibitor in the system.

6. The product of claim 1, further comprising at least one scale inhibitor.

7. The product of claim 1, further comprising at least one buffer.

8. The product of claim 1, wherein the product is substantially free of molybdate, silicate, borate, nitrite, and phosphate.

9. The product of claim 1, wherein the product comprises from about 25 wt. % to about 75 wt. % of the carboxylic acid-based corrosion inhibitor, from about 0.5 wt. % to about 5 wt. % of the azole-based corrosion inhibitor, from about 0.5 wt. % to about 10 wt. % of the nitrate-based corrosion inhibitor, and from about 25 wt. % to about 75 wt. % water.

10. A method of inhibiting corrosion of a corrosion sensitive metal in a closed loop industrial water system, the method comprising treating water in the system with a corrosion inhibiting-effective amount of a combination of:
a carboxylic acid-based corrosion inhibitor comprising a C₄₋₁₂ aliphatic monobasic acid, a C₄₋₁₂ aliphatic dibasic acid, a salt thereof, or a combination thereof;
an azole-based corrosion inhibitor; and
a nitrate-based corrosion inhibitor,
to provide a treated water, wherein the combination is substantially free of alkyl alcohols and alkylene glycols.

11. The method of claim 10, wherein the treated water comprises from about 1,000 ppm to about 20,000 ppm of the carboxylic acid-based corrosion inhibitor.

12. The method of claim 10, wherein the treated water comprises from about 20 ppm to about 1,000 ppm of the azole-based corrosion inhibitor.

13. The method of claim 10, wherein the treated water comprises from about 50 ppm to about 1,000 ppm of the nitrate-based corrosion inhibitor.

14. The method of claim 10, wherein the carboxylic acid-based corrosion inhibitor comprises adipic acid, sebacic acid, 2-ethylhexanoic acid, butanoic acid, a salt thereof, or a combination thereof.

15. The method of claim 10, wherein the method further comprises treating the water with at least one scale inhibitor.

16. The method of claim 10, further comprising treating the water with at least one buffer.

17. The method of claim 10, wherein the combination is substantially free of nitrite, molybdate, silicate, borate, and phosphate.

18. The method of claim 10, wherein the industrial water system comprises a cooling system.

19. The method of claim 10, wherein the metal comprises aluminum.

20. The method of claim 10, wherein the metal comprises an aluminum alloy 7XXX series, an aluminum alloy 2XXX series, an aluminum alloy 6XXX, a cast aluminum alloy 3XX, a cast aluminum alloy 4XX, a cast aluminum alloy 5XX, a mild steel, copper, or a combination thereof.
